(19) United States
(12) Patent Application Publication
(10) Pub. No.: US 2023/0351243 A1
(43) Pub. Date: Nov. 2, 2023

(54) UNIFICATION OF SPECIALIZED MACHINE-LEARNING MODELS FOR EFFICIENT OBJECT DETECTION AND CLASSIFICATION

(71) Applicant: Waymo LLC, Mountain View, CA (US)

(72) Inventors: Fei Xia, Sunnyvale, CA (US); Zijian Guo, Sunnywale, CA (US)

(21) Appl. No.: 17/730,436

(22) Filed: Apr. 27, 2022

(51) Int. Cl. G06N 20/00

(52) U.S. Cl. CPC G06N 20/00

(57) ABSTRACT

The described aspects and implementations enable efficient calibration of a sensing system of a vehicle. In one implementation, disclosed is a method and a system to perform the method of obtaining a plurality of target outputs generated by processing a training input using a respective teacher machine learning model (MLM) of a plurality of teacher MLMs. The training input includes a representation of one or more objects, and each of the plurality of target outputs includes a classification of the objects among a respective set of classes of a plurality of sets of classes. The method further includes using the training input and the plurality of target outputs to train a student MLM to classify the one or more objects among each of the plurality of sets of classes.

### TECHNICAL FIELD

The instant specification generally relates to systems and techniques that identify and classify objects in applications that include, but are not limited to autonomous vehicles and vehicles deploying driver assistance technology. More specifically, the instant specification relates to using multiple specialized machine learning models to train a unified model capable of combining functionalities of the specialized models and performing efficient on-board object detection and classification.

### BACKGROUND

An autonomous (fully or partially self-driving) vehicle (AV) operates by sensing an outside environment with various electromagnetic (e.g., radar and optical) and non-electromagnetic (e.g., audio and humidity) sensors. Some autonomous vehicles chart a driving path through the environment based on the sensed data. The driving path can be determined based on Global Navigation Satellite System (GNSS) data and road map data. While the GNSS and the road map data can provide information about static aspects of the environment (buildings, street layouts, road closures, etc.), dynamic information (such as information about other vehicles, pedestrians, street lights, etc.) is obtained from contemporaneously collected sensing data. Precision and safety of the driving path and of the speed regime selected by the autonomous vehicle depend on timely and accurate identification of various objects present in the driving environment and on the ability of a driving algorithm to process the information about the environment and to provide correct instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 is a diagram illustrating components of an example autonomous vehicle (AV) capable of deploying unified models trained using the teacher-student framework and capable of performing multiple concurrent classifications of objects and states of the objects, in accordance with some implementations of the present disclosure.

FIG. 2 is a diagram illustrating example architecture of a part of a perception system that is capable of deploying one or more unified models trained by multiple teacher models and capable of performing multiple tasks, in accordance with some implementations of the present disclosure.

FIG. 3 is a schematic diagram illustrating example operations performed during training of multiple teacher models, in accordance with some implementations of the present disclosure.

FIG. 4 is a schematic diagram illustrating example operations performed during training of a unified model capable of performing multiple tasks, in accordance with some implementations of the present disclosure..

FIGS. 5A-D illustrate schematically a framework for updating a unified model to perform an additional task or to improve performance of an existing task, in accordance with some implementations of the present disclosure.

FIG. 6 illustrates an example method of training, using multiple teacher models, of a unified model capable of performing multiple tasks, in accordance with some implementations of the present disclosure.

FIG. 7 illustrates an example method of augmenting training of a unified model to perform additional tasks, in accordance with some implementations of the present disclosure

FIG. 8 depicts a block diagram of an example computer device capable of training one or more unified models using multiple teacher models, in accordance with some implementations of the present disclosure.

### SUMMARY

In one implementation, disclosed is a method that includes obtaining a plurality of target outputs, each of the plurality of target outputs including a classification of a training input among a respective set of classes of a plurality of sets of classes. Each of the plurality of sets of classes is obtained using a respective teacher machine learning model (MLM) of a plurality of teacher MLMs. The training input includes a representation of one or more objects. The method further includes using the training input and the plurality of target outputs to train a student MLM to classify the one or more objects among each of the plurality of sets of classes.

In another implementation, disclosed is system that includes a memory device and a processing device communicatively coupled to the memory device. The processing device is configured to obtain a plurality of target outputs, each of the plurality of target outputs including a classification of a training input among a respective set of classes of a plurality of sets of classes. Each of the plurality of sets of classes is obtained using a respective teacher MLM of a plurality of teacher MLMs. The training input includes a representation of one or more objects. The processing device is further configured to use the training input and the plurality of target outputs to train a student MLM to classify the one or more objects among each of the plurality of sets of classes.

In another implementation, disclosed is a non-transitory computer-readable medium storing instructions thereon that, when executed by a processing device, cause the processing device to perform operations that include obtaining a plurality of target outputs, each of the plurality of target outputs comprises a classification of a training input among a respective set of classes of a plurality of sets of classes. Each of the plurality of sets of classes is obtained using a respective teacher MLM of a plurality of teacher MLMs. The training input includes a representation of one or more objects. The operations further include using the training input and the plurality of target outputs to train a student MLM to classify the one or more objects among each of the plurality of sets of classes.

### DETAILED DESCRIPTION

Although various implementations may be described below, for the sake of illustration, using autonomous driving systems and driver assistance systems as examples, it should be understood that the techniques and systems described herein can be used for identification of objects and states of objects in a wide range of applications, including aeronautics, marine applications, traffic control, animal control, industrial and academic research, public and personal safety, or in any other application where automated detection of objects is advantageous.

In one example, for the safety of autonomous driving operations, it can be desirable to develop and deploy techniques of fast and accurate detection, classification, and tracking of various road users and other objects encountered on or near roadways, such as road obstacles, construction equipment, roadside structures, and the like. An autonomous vehicle (as well as various driver assistance systems) can take advantage of a number of sensors to facilitate detection of objects in a driving environment and determine the motion of such objects. The sensors typically include radio detection and ranging sensors (radars), light detection and ranging sensors (lidars), digital cameras of multiple types, sound navigation and ranging sensors (sonars), positional sensors, and the like. Different types of sensors provide different and often complementary benefits. For example, radars and lidars emit electromagnetic signals (radio signals or optical signals) that reflect from the objects and carry information allowing to determine distances to the objects (e.g., from the time of flight of the signals) and velocities of the objects (e.g., from the Doppler shift of the frequencies of the signals). Radars and lidars can cover an entire 360-degree view, e.g., by using a scanning transmitter of sensing beams. Sensing beams can cause numerous reflections covering the driving environment in a dense grid of return points. Each return point can be associated with the distance to the corresponding reflecting object and a radial velocity (a component of the velocity along the line of sight) of the reflecting object.

Existing systems and methods of object identification and tracking use various sensing modalities, e.g., lidars, radars, cameras, etc., to obtain images of the environment. The images can then be processed by trained machine learning models to identify locations of various objects in the images (e.g., in the form of bounding boxes), state of motion of the objects (e.g., speed, as detected by lidar or radar Doppler effect-based sensors), type of the object (e.g., a vehicle or pedestrian), and so on. Existing techniques of machine learning often involve constructing and training separate models for highly specialized tasks. For example, one model can determine a type of an object, e.g., a passenger car, a truck, a pedestrian, and so on. Another model can identify position and orientation (“pose”) of the object. Another model can identify a state of braking lights of the object (e.g., vehicle). Yet another model can identify a state of turning (or hazard) lights of the object, and so on. However, different models often have a similar architecture and are configured to process similar input data (or representations of the input data), e.g., lidar/radar/camera images of the objects. This leads to a redundant processing that has a high computational cost, which makes the existing stacks of machine learning models difficult to deploy on vehicles that lack powerful computational hardware. Additionally, individual models often fail to take advantage of the fact that classifications determined by some models could be beneficial for performance of other models. For example, an output of a model that identifies a state of the turning lights of a vehicle correlates and, therefore, could be advantageous for determination of the pose of the vehicle on the roadway.

Aspects and implementations of the present disclosure address these and other shortcomings of the existing machine learning technology by enabling methods and systems for efficient training of unified models that combine functionality of highly specialized models while also capturing benefits provided by concurrent processing of correlated tasks. In some implementations, a set of specialized models, each trained for a specific task, can be used as teacher models that train a unified student model to perform multiple tasks concurrently. The disclosed techniques provide a framework for flexible training of such unified models. For example, teacher models can originally be trained with ground truth that includes manually-annotated training data, such as annotated lidar images, radar images, optical range camera images, infrared range camera images, sonar images, or any other data, as well as any combination thereof. Subsequently, trained teacher models can be used to process a set of input data and generate automated annotations for the input data. The set of data can include some data used for training of the teacher models or can be (or include) new data not previously seen by teacher models.

Automation of the annotation process enables generation of a significant amount of training inputs and ground truth that is then used for training of one or more unified models. The ground truth may include a final classification of the teacher models (e.g., “most likely a pedestrian,” “most likely a passenger car,” etc.), soft classification including classification probabilities (e.g., “60% likely a pedestrian/30% likely a bicyclist/10% likely a motorcyclist,” etc.), as well as various intermediate outputs of the teacher models, e.g., any outputs of hidden neuron layers of the teacher models. In some implementations, the ground truth for training of the unified model may also include manual annotations of the training data.

Advantages of the disclosed implementations include but are not limited to development of an efficient framework of generation and deployment of unified models that combine functionality of multiple specialized models and can operate effectively on systems with moderate computational resources. Moreover, since the unified models are trained by teaching models that are specialized on performing a diverse set of tasks, during the training process the unified models learn to identify correlations in the input data that bear on classifications related to different tasks. For example, a unified model can learn to correlate the state of the lights of a vehicle with the state of the motion of the same vehicle (or other vehicles). As a result, the unified model learns how to accurately predict motion of the vehicle, in contrast to the conventional techniques where such predictions typically require substantial post-processing that fuses together predictions of individual specialized models. Additionally, since teacher models are used during off-board training of unified models, the teacher models are not subject to any computational constraints and can be large and expensive and of a much higher quality than traditional onboard specialized models. Furthermore, the described framework allows a significant flexibility at the design time, as different groups of engineers can use the same backbone of the unified model while making adjustments (e.g., via additional task-focused training) to the architecture and/or parameters of specific classification heads responsible for various individual tasks. Such adjustments can first be tried and verified during an off-board testing before being deployed on-board, e.g., during actual driving missions.

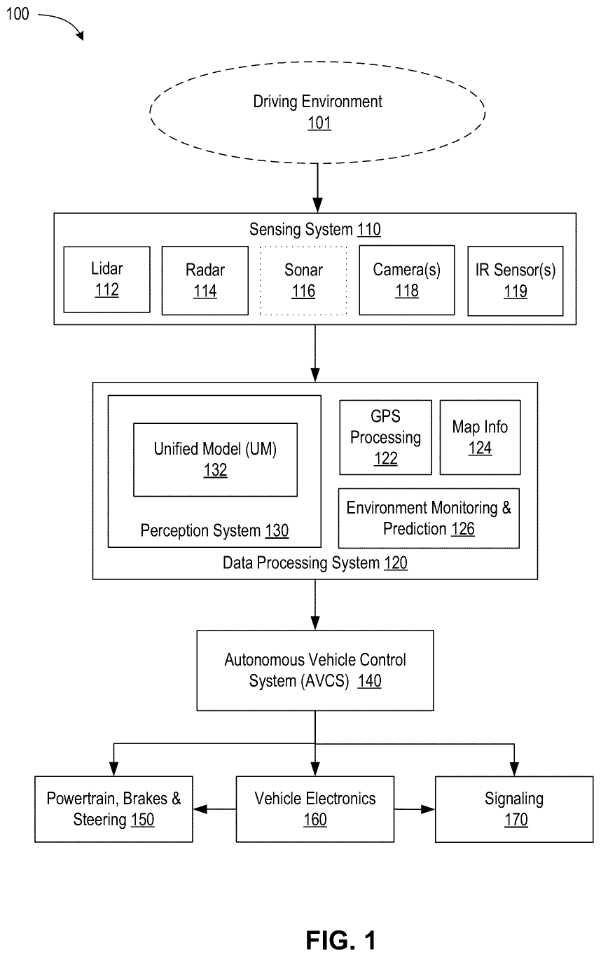

FIG. 1 is a diagram illustrating components of an example autonomous vehicle (AV) 100 capable of deploying unified models trained using the teacher-student framework and capable of performing multiple concurrent classifications of objects and states of the objects, in accordance with some implementations of the present disclosure. Autonomous vehicles can include motor vehicles (cars, trucks, buses, motorcycles, all-terrain vehicles, recreational vehicles, any specialized farming or construction vehicles, and the like), aircraft (planes, helicopters, drones, and the like), naval vehicles (ships, boats, yachts, submarines, and the like), spacecraft (controllable objects operating outside Earth atmosphere) or any other self-propelled vehicles (e.g., robots, factory or warehouse robotic vehicles, sidewalk delivery robotic vehicles, etc.) capable of being operated in a self-driving mode (without a human input or with a reduced human input).

Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

As described herein, in a semi-autonomous or partially autonomous driving mode, even though the vehicle assists with one or more driving operations (e.g., steering, braking and/or accelerating to perform lane centering, adaptive cruise control, advanced driver assistance systems (ADAS), or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods may be described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such driving assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

A driving environment 101 can include any objects (animate or inanimate) located outside the AV, such as roadways, buildings, trees, bushes, sidewalks, bridges, mountains, other vehicles, pedestrians, piers, banks, landing strips, animals, birds, and so on. The driving environment 101 can be urban, suburban, rural, and so on. In some implementations, the driving environment 101 can be an off-road environment (e.g. farming or other agricultural land). In some implementations, the driving environment can be an indoor environment, e.g., the environment of an industrial plant, a shipping warehouse, a hazardous area of a building, and so on. In some implementations, the driving environment 101 can be substantially flat, with various objects moving parallel to a surface (e.g., parallel to the surface of Earth). In other implementations, the driving environment can be three-dimensional and can include objects that are capable of moving along all three directions (e.g., balloons, falling leaves, etc.). Hereinafter, the term “driving environment” should be understood to include all environments in which an autonomous motion (e.g., SAE Level 5 and SAE Level 4 systems), conditional autonomous motion (e.g., SAE Level 3 systems), and/or motion of vehicles equipped with driver assistance technology (e.g., SAE Level 2 systems) can occur. Additionally, “driving environment” can include any possible flying environment of an aircraft (or spacecraft) or a marine environment of a naval vessel. The objects of the driving environment 101 can be located at any distance from the AV, from close distances of several feet (or less) to several miles (or more).

The example AV 100 can include a sensing system 110. The sensing system 110 can include various electromagnetic (e.g., optical, infrared, radio wave, etc.) and non-electromagnetic (e.g., acoustic) sensing subsystems and/or devices. The sensing system 110 can include one or more lidars 112, which can be a laser-based unit capable of determining distances to the objects and velocities of the objects in the driving environment 101. The sensing system 110 can include one or more radars 114, which can be any system that utilizes radio or microwave frequency signals to sense objects within the driving environment 101 of the AV 100. The lidar(s) 112 and or radar(s) 114 can be configured to sense both the spatial locations of the objects (including their spatial dimensions) and velocities of the objects (e.g., using the Doppler shift technology). Hereinafter, “velocity” refers to both how fast the object is moving (the speed of the object) as well as the direction of the object's motion. Each of the lidar(s) 112 and radar(s) 114 can include a coherent sensor, such as a frequency-modulated continuous-wave (FMCW) lidar or radar sensor. For example, lidar(s) 112 and/or radar(s) 114 can use heterodyne detection for velocity determination. In some implementations, the functionality of a ToF and coherent lidar (or radar) is combined into a lidar (or radar) unit capable of simultaneously determining both the distance to and the radial velocity of the reflecting object. Such a unit can be configured to operate in an incoherent sensing mode (ToF mode) and/or a coherent sensing mode (e.g., a mode that uses heterodyne detection) or both modes at the same time. In some implementations, multiple lidars 112 and/or radar 114s can be mounted on AV 100.

Lidar 112 (and/or radar 114) can include one or more optical sources (and/or radio/microwave sources) producing and emitting signals and one or more detectors of the signals reflected back from the objects. In some implementations, lidar 112 and/or radar 114 can perform a 360-degree scanning in a horizontal direction. In some implementations, lidar 112 and/or radar 114 can be capable of spatial scanning along both the horizontal and vertical directions. In some implementations, the field of view can be up to 90 degrees in the vertical direction (e.g., with at least a part of the region above the horizon being scanned with lidar or radar signals). In some implementations (e.g., aerospace applications), the field of view can be a full sphere (consisting of two hemispheres).

The sensing system 110 can further include one or more cameras 118 to capture images of the driving environment 101. Cameras 118 can operate in the visible part of the electromagnetic spectrum, e.g., 300-800 nm range of wavelengths (herein also referred for brevity as the optical range). Some of the optical range cameras 118 can use a global shutter while other cameras 118 can use a rolling shutter. The images can be two-dimensional projections of the driving environment 101 (or parts of the driving environment 101) onto a projecting surface (flat or non-flat) of the camera(s). Some of the cameras 118 of the sensing system 110 can be video cameras configured to capture a continuous (or quasi-continuous) stream of images of the driving environment 101. The sensing system 110 can also include one or more sonars 116, for active sound probing of the driving environment 101, e.g., ultrasonic sonars, and one or more microphones for passive listening to the sounds of the driving environment 101. The sensing system 110 can also include one or more infrared range cameras 119 also referred herein as IR cameras 119. IR camera(s) 119 can use focusing optics (e.g., made of germanium-based materials, silicon-based materials, etc.) that is configured to operate in the range of wavelengths from microns to tens of microns or beyond. IR camera(s) 119 can include a phased array of IR detector elements. Pixels of IR images produced by camera(s) 119 can be representative of the total amount of IR radiation collected by a respective detector element (associated with the pixel), of the temperature of a physical object whose IR radiation is being collected by the respective detector element, or any other suitable physical quantity.

The sensing data obtained by the sensing system 110 can be processed by a data processing system 120 of AV 100. For example, the data processing system 120 can include a perception system 130. The perception system 130 can be configured to detect and track objects in the driving environment 101 and to recognize the detected objects. For example, the perception system 130 can analyze images captured by the cameras 118 and can be capable of detecting traffic light signals, road signs, roadway layouts (e.g., boundaries of traffic lanes, topologies of intersections, designations of parking places, and so on), presence of obstacles, and the like. The perception system 130 can further receive radar sensing data (Doppler data and ToF data) to determine distances to various objects in the environment 101 and velocities (radial and, in some implementations, transverse, as described below) of such objects. In some implementations, the perception system 130 can use radar data in combination with the data captured by the camera(s) 118, as described in more detail below.

The perception system 130 can include one or more unified models 132 to facilitate classification of objects and states of the objects for a plurality of tasks using image data provided by the sensing system 110. More specifically, in some implementations, unified model 132 can receive data from sensors of different sensing modalities. For example, unified model 132 can receive images from at least some of lidar(s) 112, radar(s) 114, (optical range) camera(s) 118, IR camera (s) 119, sonar(s) 116, and so on. Unified model 132 can include one or more trained machine-learning models (MLMs) that process the received images, detect depictions of various objects in the images, link the detected objects among images with different timestamps, and classify the objects and states of the objects. Processing of the linked objects together (e.g., concurrently or sequentially) allows unified model 132 to determine object classifications that would not be revealed by processing of individual images. For example, static images of blinking hazard lights could depict the lights in the on-state and the off-state while the true state of the lights would be revealed by a linked combination of two or more such images (frames).

Unified model 132 can have a common backbone and can further deploy multiple classification heads that output classifications corresponding to different tasks (categories). Unified model 132 can be trained using multiple sets of frames, annotated with identifications of objects in individual frames as well as with inter-frame associations (links) between the objects. During inference, unified model 132 can detect objects in linked sets of frames, classify detected objects and states of the detected objects among a plurality of classes for each classification task (category). In some implementations, processing of linked sets of frames can be performed using recurrent neural networks with memory, transformer neural networks with attention layers, and other neural networks trained using multiple teacher models, as described in more detail below.

The perception system 130 can further receive information from a Global Navigation Satellite System (GNSS) positioning subsystem (not shown in FIG. 1), which can include a GNNS transceiver (not shown), configured to obtain information about the position of the AV relative to Earth and its surroundings. The positioning subsystem can use the positioning data, e.g., GNNS and inertial measurement unit (IMU) data) in conjunction with the sensing data to help accurately determine the location of the AV with respect to fixed objects of the driving environment 101 (e.g. roadways, lane boundaries, intersections, sidewalks, crosswalks, road signs, curbs, surrounding buildings, etc.) whose locations can be provided by map information 124. In some implementations, the data processing system 120 can receive non-electromagnetic data, such as audio data (e.g., ultrasonic sensor data from sonar 116 or data from microphone picking up emergency vehicle sirens), temperature sensor data, humidity sensor data, pressure sensor data, meteorological data (e.g., wind speed and direction, precipitation data), and the like.

The data processing system 120 can further include an environment monitoring and prediction component 126, which can monitor how the driving environment 101 evolves with time, e.g., by keeping track of the locations and velocities of the animated objects (e.g., relative to Earth). In some implementations, the environment monitoring and prediction component 126 can keep track of the changing appearance of the environment due to a motion of the AV relative to the environment. In some implementations, the environment monitoring and prediction component 126 can make predictions about how various animated objects of the driving environment 101 will be positioned within a prediction time horizon. The predictions can be based on the current state of the animated objects, including current locations (coordinates) and velocities of the animated objects. Additionally, the predictions can be based on a history of motion (tracked dynamics) of the animated objects during a certain period of time that precedes the current moment. For example, based on stored data for a first object indicating accelerated motion of the first object during the previous 3-second period of time, the environment monitoring and prediction component 126 can conclude that the first object is resuming its motion from a stop sign or a red traffic light signal. Accordingly, the environment monitoring and prediction component 126 can predict, given the layout of the roadway and presence of other vehicles, where the first object is likely to be within the next 3 or 5 seconds of motion. As another example, based on stored data for a second object indicating decelerated motion of the second object during the previous 2-second period of time, the environment monitoring and prediction component 126 can conclude that the second object is stopping at a stop sign or at a red traffic light signal. Accordingly, the environment monitoring and prediction component 126 can predict where the second object is likely to be within the next 1 or 3 seconds. The environment monitoring and prediction component 126 can perform periodic checks of the accuracy of its predictions and modify the predictions based on new data obtained from the sensing system 110. The environment monitoring and prediction component 126 can operate in conjunction with unified model 132. For example, the environment monitoring and prediction component 126 can track relative motion of the AV and various objects (e.g., reference objects that are stationary or moving relative to Earth); in some implementations.

The data generated by the perception system 130, the GLASS processing module 122, and the environment monitoring and prediction component 126 can be used by an autonomous driving system, such as AV control system (AVCS) 140. The AVCS 140 can include one or more algorithms that control how AV is to behave in various driving situations and environments. For example, the AVCS 140 can include a navigation system for determining a global driving route to a destination point. The AVCS 140 can also include a driving path selection system for selecting a particular path through the immediate driving environment, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (rocks, stalled vehicles, and so on) within the driving environment of the AV. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

Algorithms and modules of AVCS 140 can generate instructions for various systems and components of the vehicle, such as the powertrain, brakes, and steering 150, vehicle electronics 160, signaling 170, and other systems and components not explicitly shown in FIG. 1. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions output by the AVCS 140 can be delivered directly to the powertrain, brakes, and steering 150 (or signaling 170) whereas other instructions output by the AVCS 140 are first delivered to the vehicle electronics 160, which generates commands to the powertrain, brakes, and steering 150 and/or signaling 170.

In one example, unified model 132 can determine that the last 10 frames of lidar-camera combined data depict a semi-truck traveling on a highway and having the stopping lights and the right-turn light activated. Responsive to such a determination, the data processing system 120 of a vehicle can determine that the semi-truck is about to stop/park on the shoulder of the highway. The data processing system 120 of the vehicle can also determine that the left lane is occupied and unavailable to accept the vehicle. The data processing system 120 can then determine that the vehicle needs to slow down until the semi-truck clears the roadway. The AVCS 140 can output instructions to the powertrain, brakes, and steering 150 (directly or via the vehicle electronics 160) to: (1) reduce, by modifying the throttle settings, a flow of fuel to the engine to decrease the engine rpm; (2) downshift, via an automatic transmission, the drivetrain into a lower gear; and (3) engage a brake unit to reduce (while acting in concert with the engine and the transmission) the vehicle's speed until the safe speed is reached. In the meantime, unified model 132 can continue tracking the semi-truck to confirm that the semi-truck is continuing the stopping maneuver. Subsequently, the AVCS 140 can output instructions to the powertrain, brakes, and steering 150 to resume the previous speed settings of the vehicle.

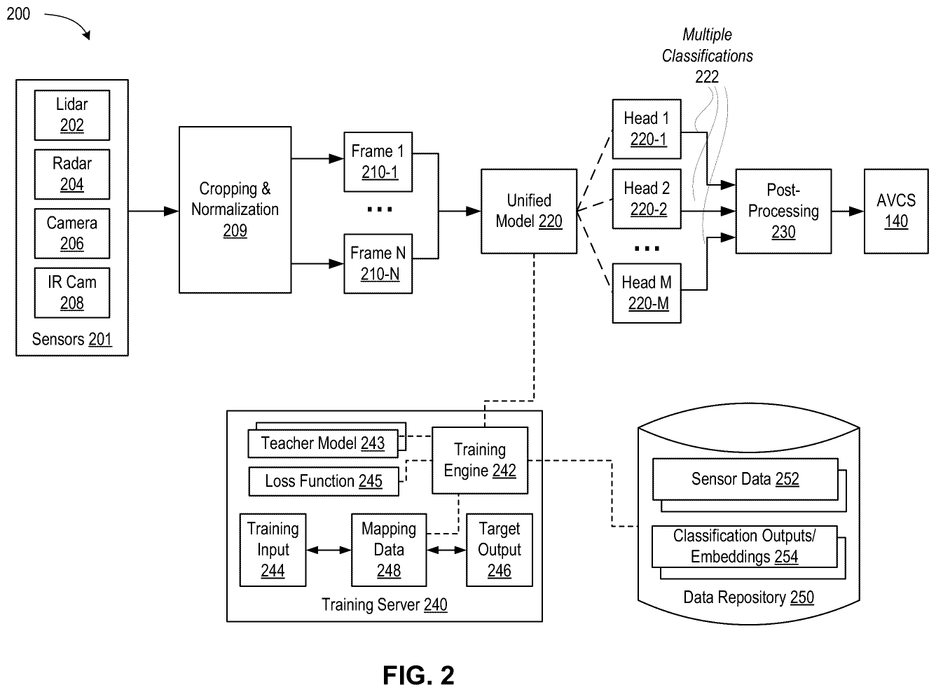

FIG. 2 is a diagram illustrating example architecture 200 of a part of a perception system that is capable of deploying one or more unified models trained by multiple teacher models and capable of performing multiple tasks, in accordance with some implementations of the present disclosure. An input into the perception system (e.g., perception system 130 of FIG. 1) can include data obtained by various components of the sensing system 110, e.g., sensors 201, which can include lidar sensor(s) 202, radar sensor(s) 204, optical (e.g., visible) range camera(s) 206, IR camera(s) 208, and so on. The data output by various sensors 201 can include directional data (e.g., angular coordinates of return points), distance data, and radial velocity data, e.g., as can be obtained by lidar sensor(s) 202 and/or radar sensor(s) 204. The data output by various sensors 201 can further include pixel data obtained by optical range camera(s) 206 and pixel data obtained by IR camera(s) 208. The data generated by a particular sensor (e.g., lidar 202) in association with a particular instance of time is referred to herein as an image (e.g., a lidar image). A set of all available images (a lidar image, a radar image, a camera image, and/or an IR camera image, etc.) associated with a specific instance of time is referred to as a sensing frame or, simply, frame herein. In some implementations, the images obtained by different sensors can be synchronized, so that all images in a given sensing frame have the same (up to an accuracy of synchronization) timestamp. In some implementations, some images in a given sensing frame can have (controlled) time offsets. It should be understood that any frame can include all or only some of the data modalities, e.g., only lidar data and camera data, or only camera data.

An image obtained by any of the sensors can include a corresponding intensity map I({xⱼ}) where {xⱼ} can be any set of coordinates, including three-dimensional (spherical, cylindrical, Cartesian, etc.) coordinates (e.g., in the instances of lidar and/or radar images), or two-dimensional coordinates (in the instances of camera data). Coordinates of various objects (or surfaces of the objects) that reflect lidar and/or radar signals can be determined from directional data (e.g., polar θ and azimuthal ϕ angles in the direction of lidar/radar transmission) and distance data (e.g., radial distance R determined from the ToF of lidar/radar signals). The intensity map can identify intensity of sensing signals detected by the corresponding sensors. Similarly, lidar and/or radar sensors can produce a Doppler (frequency shift) map, Δf ({xⱼ}) that identifies (radial) velocity V of reflecting objects based on a detected Doppler shift Δf of the frequency of the reflected radar signals, V=λΔf/2, where λ is the lidar/radar wavelength, with positive values Δf>0 associated with objects that move towards the lidar/radar (and, therefore, the vehicle) and negative values Δf<0 associated with objects that move away from the lidar/radar. In some implementations, e.g., in driving environments where objects are moving substantially within a specific plane (e.g., parallel to ground), the radar intensity map and the Doppler map can be defined using two-dimensional coordinates, such as the radial distance and azimuthal angle: (R, ϕ), Δf (R, ϕ). Lidar and/or radar data can be identified with timestamps.

Camera(s) 218 can acquire one or more sequences of images, which can be similarly identified with timestamps. Each image can have pixels of various intensities of one color (for black-and-white images) or multiple colors (for color images). Images acquired by camera(s) 206 can be panoramic images or images depicting a specific portion of the driving environment, such as a large (e.g., panoramic) image segmented into smaller images or images acquired by limited-view cameras (e.g., frontal-view cameras, rear-view cameras, side-view cameras, etc.). Infrared camera(s) 208 can similarly output one or more sequences of IR images. Each IR image can be obtained by an array of infrared detectors, which can operate in the range of wavelengths from microns to tens of microns or beyond. The IR images can include intensity I({xⱼ}) representative of the total amount of IR radiation collected by a respective detector. In some implementations, the IR images can include a pseudo-color map Cᵢ({xⱼ}) in which the presence of a particular pseudo-color Cᵢ can be representative of the collected total intensity I({xⱼ}). In some implementations, the collected intensity I({xⱼ}) can be used to determine a temperature map T({xⱼ}) of the environment. Accordingly, in different implementations, different representations (e.g., intensity maps, pseudo-color maps, temperature maps, etc.) can be used to represent the IR camera data.

In some implementations, sensors 201 can output portions of sensing frames in association with particular segments of the driving environment. For example, data generated by a frontal-view optical range camera can be bundled with data generated with a frontal-view IR camera and further bundled with a portion of lidar and/or radar data obtained by sensing beams transmitted within a certain (e.g., forward-looking) segment of the lidar and/or radar cycle that corresponds to the field of view of the frontal view cameras. Similarly, a side-view camera data can be bundled with a lidar and/or radar data obtained by the sensing beams transmitted within a respective side-view segment of the lidar and/or radar scanning.

Architecture 200 can include a cropping and normalization module 209 that can crop one or more portions of sensing data of any particular sensing frame. For example, cropping and normalization module 209 can select (crop) a portion of sensing data for a particular sector of view, e.g., forward view, side view, rearward view, etc. In some implementations, cropping and normalization module 209 can combine available data of different sensing modalities, e.g., lidar images, radar images, optical range camera images, IR camera images, and the like, such that the data for different sensing modalities correspond to the same regions of the driving environment. The combined data can associate intensities of multiple modalities (e.g., camera intensities and lidar intensities) with the same pixel (or voxel) corresponding to a given region of the environment. The combined data can be associated with different frames 210-1 . . . 210-N. For example, cropping and normalization module 209 can generate combined images of a particular object cropped out of data of multiple frames corresponding to times t₁ . . . t_{N}.

Cropping and normalization module 209 can resize each (e.g., combined) image to match the size of an input into a unified model 220. For example, if unified model 220 is configured to process inputs of dimension n×m while a cropped portion of a camera image has a size of N×M pixels, cropping and normalization module 209 can resize, e.g., downscale or upscale, the cropped portion, depending on whether the cropped portion is larger or smaller than the size of unified model 220 inputs. In some implementations, the rescaling is performed while preserving the aspect ratio of the cropped portion. For example, if the dimension of unified model 220 inputs is 256×192 pixels, and the size of the cropped portion is 96×96 pixels, cropping and normalization module 209 can upscale the cropped portion using a rescaling factor 2, such that the resized portion has the size of is 192×192 pixels. Because the size of the upscaled portion is less than the size of unified model 220 inputs, the upscaled portion can then be padded to the size of 256×192 pixels, e.g., using padding pixels. The intensity of the padding pixels can be the average intensity of the pixels of the cropped portion, the intensity of edge pixels, a nominal intensity, or any other suitably chosen intensity.

In some implementations, cropping and normalization module 209 can normalize the intensity of the pixels of the cropped portion to a preset range of intensities, e.g., [Iₘᵢₙ, Iₘₐₓ], where Iₘᵢₙ is the minimum intensity and Iₘₐₓ is the maximum intensity that unified model 220 is configured to process. In some implementations, the minimum intensity can be zero, Iₘᵢₙ=0. The intensity rescaling factor can be determined by identifying the maximum intensity max in the cropped portion, e.g., R=Iₘₐₓ/iₘₐₓ. Each pixel intensity can then be rescaled using the determined factor R. Since different sensing modalities can have different intensities (including the maximum intensities iₘₐₓ), different rescaling factors R can be used for lidar/radar/camera/IR camera images and portions of the images. Additionally, cropping and normalization module 209 can perform other preprocessing of the cropped portions including filtering, denoising, and the like.

Unified model 220 can process all, some, or a single data modality output by sensors 201 (e.g., only camera data or both camera data and lidar data, etc.) to perform concurrently multiple tasks that can include classifying an object (or multiple objects) depicted in frames 210-1 . . . 210-N over a number of categories, each category including multiple classes. For example, a first category can include a type of the object (with classes corresponding to a pedestrian, a passenger car, a sports utility vehicle, a bus, etc.); a second category can include a type of the motion of the object (with classes corresponding to a parked car, a cruising vehicle, a braking vehicle, a vehicle performing a lane change, etc.) A third category can include a status of the external lights of the vehicle (with classes corresponding to no lights, steady low-beam lights, brake lights, turning signal on, hazard lights on, etc.), and so on.

Unified model 220 can process multiple frames 210-1 . . . 210-N together or in a correlated, time-fused, fashion. More specifically, unified model 220 can process frames 210-1 . . . 210-N concurrently, e.g., using the images of the corresponding frames as concatenated data. In such implementations, unified model 220 can include one or more attention layers (e.g., arranged in a transformer network architecture). In some implementations, unified model 220 can process frames 210-1 . . . 210-N sequentially, e.g., in a pipelined fashion. In such implementations, unified model 220 can include one or more memory layers (e.g., arranged in a recurrent network architecture).

Unified model 220 can be any suitable machine-learning model capable of classifying objects present in frames 210-1 . . . 210-N or combination of the objects. Unified model 220 can be (or include) one or more MLMs having any suitable architecture that can use lookup-tables, geometric shape mapping, mathematical formulas, decision-tree algorithms, support vector machines, deep neural networks, etc., or any combination thereof. In some implementations, unified model 220 can deploy a deep neural networks such as a convolutional neural network, recurrent neural networks (RNN) with one or more hidden layers, fully connected neural networks, long short-term memory neural networks, Boltzmann machines, transformer neural networks with attention layers, and so on, or any combination thereof

Unified model 220 can include a common backbone and a number of classification heads, e.g., heads 220-1 . . . 220-M. Each head 220-n can correspond to a respective classification task (category) and output classification probabilities for multiple classes. Multiple classifications 222 output by unified model 220, can undergo additional post-processing stage 230 that can include tracking various objects across different frames, tracking a change in the state of the objects, predicting future dynamics of the objects, and so on. For example, a state of a particular object (e.g., an object that activated a right-turn signal and began deceleration) determined over the first N frames obtained at times t₁, t₂ . . . t_{N} can be linked to a state of the same object within the second N frames obtained at times t_{N+1}, t_{N+2} . . . t_{2N} (e.g., the object coming to a stop near the side of the roadway), and so on. Post-processing stage 230 can further include generating any graphical, such as pixel-based (e.g., heat map) or curve-based (vectorized), representations of the characteristics of the objects, including trajectories, poses, speed regime of various objects, and the like. In some implementations, post-processing stage 230 can include processing the detected dynamics of the object using one or more physical models that predict motion of the objects, e.g., a model that tracks velocity, acceleration, etc., of the detected objects. For example, a Kalman filter or any other suitable filter, which combines predicted motion of a particular object with the detected motion of the object, can be used for more accurate estimation of the actual location and motion of the object.

Tracking data generated by unified model 220 and post-processing stage 230 can be provided to AVCS 140. AVCS 140 evaluates the dynamics and characteristics of various objects and determines whether to modify the current driving trajectory of the vehicle in view of the location and speed of the tracked objects. For example, if a tracked pedestrian or bicyclist is within a certain distance from the vehicle, the AVCS 140 can slow the vehicle down to a speed that ensures that the pedestrian or bicyclist can be safely avoided. Alternatively, AVCS 140 can change lanes, e.g., if an adjacent lane is free from obstructions, or perform some other driving maneuver.

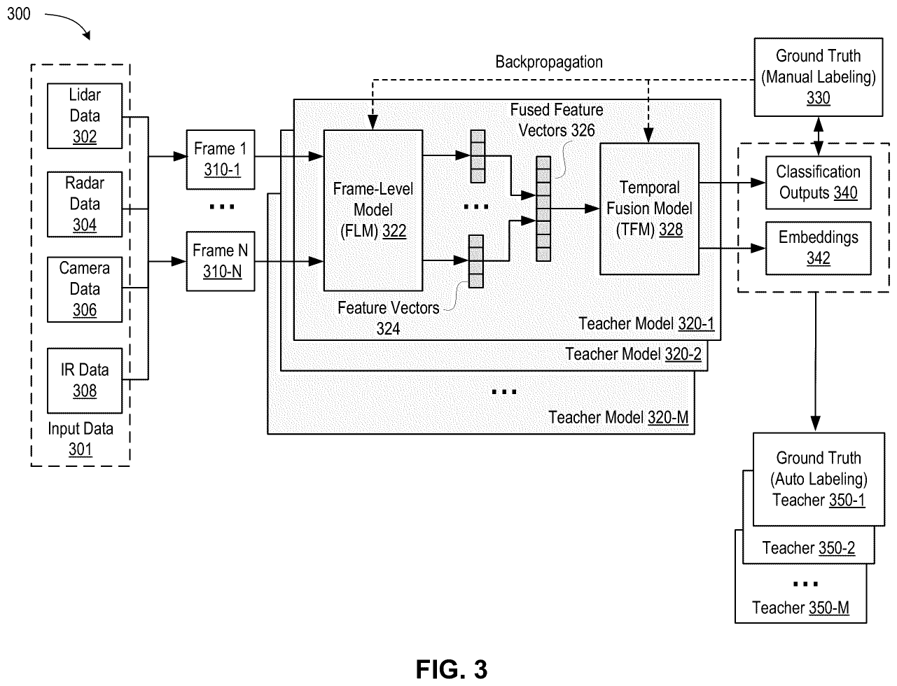

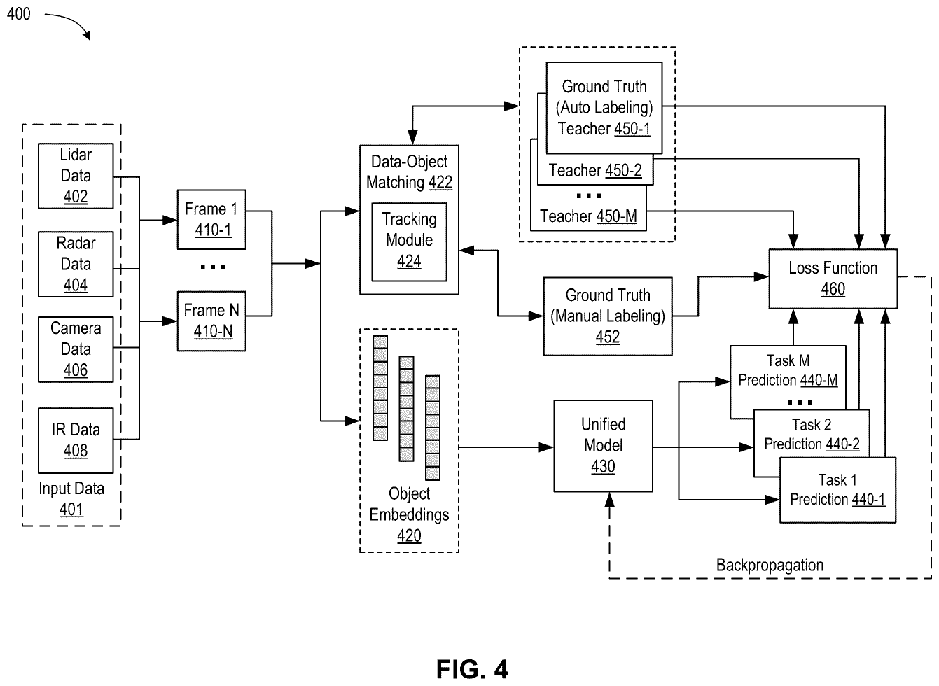

Training can be performed by a training engine 242 hosted by a training server 240, which can be an outside server that deploys one or more processing devices, e.g., central processing units (CPUs), graphics processing units (GPUs), etc. In some implementations, unified model 220 can be trained by training engine 242 and subsequently downloaded onto the vehicle that deploys perception system 130. Unified model 220 can be trained, as described in more detail in conjunction with FIG. 3 and FIG. 4 using training data that includes training inputs 244 and corresponding target outputs 246 (correct matches for the respective training inputs). During training of unified model 220, training engine 242 can find patterns in the training data that map each training input 244 to the target output 246.

In some implementations, unified model 220 can be trained in stages, the first step involving training of multiple specialized teacher models 243 using sensing images and other data that have been recorded during driving missions and annotated (e.g., manually) with ground truth. For training of teacher models 243, ground truth (target output 246) can include correct identification of various objects and classifications of those objects according to specific tasks (categories) that the respective teacher model 243 is being trained to perform. For training of unified model 220, ground truth can include not only manually-annotated classification of objects but also outputs of previously trained teacher models 243. In some implementations, training of unified model 220 can be performed using the outputs of trained teacher models 243 but without manually-annotated ground truth. In some implementations, ground truth for training of unified model 220 may include soft classifications of various objects present in the training inputs 244, e.g., probabilities of the objects belonging to different classes. In some implementations, ground truth for training of unified model 220 may include intermediate outputs of teacher models 243, e.g., outputs of any hidden layer of a specific teacher model 243. In some implementations, ground truth for training of teacher models 243 and/or unified model 220 can include images obtained by the sensors of the specific modalities that are to be deployed on a particular autonomous driving or driver assistance platform. For example, unified model 220 intended to be used with lidar data, optical range camera data, and IR data can be trained with the corresponding sets of training data obtained with lidars, optical range cameras, and IR cameras. During training of a different unified model 220 that is to be used with radar data in place of the lidar data, the lidar training images can be replaced with radar training images.

Training engine 242 can have access to a data repository 250 storing multiple sensor data 252, e.g., camera/IR camera images, lidar images, radar images, etc., obtained during driving situations in a variety of driving environments (e.g., urban driving missions, highway driving missions, rural driving missions, etc.). During training, training engine 242 can select (e.g., randomly), as training data, a number of sets of sensor data 252. Before the annotated training data is placed into data repository 250, the training data can be annotated, e.g. by a developer, with correct object identifications, which can include classification outputs 254. In some implementations, annotations can be made by various teacher models 243. In such implementations, classification outputs 254 can include embedding or any suitable intermediate outputs of teacher models 243.

Annotated training data retrieved by training server 240 from data repository 250 can include one or more training inputs 244 and one or more target outputs 246. Training data can also include mapping data 248 that maps training inputs 244 to target outputs 246. For example, mapping data 248 can identify a bounding box of a passenger car and locations of visible lights of the passenger car in each (or some) of a batch of N consecutive frames obtained by a forward-facing camera of a vehicle. The mapping data 248 can include an identifier of the training data, a location of the passenger car, size and identification of the passenger car, speed and direction of motion of the passenger car, status of the lights of the passenger car, and other suitable information.

During training of unified model 220, training engine 242 can use a loss function 245 to evaluate the difference between outputs of unified model 220 and target outputs 246. Training engine 242 can then change parameters (e.g., weights and biases) of unified model 220 until the model successfully learns how to minimize loss function 245 and, therefore, reproduce (or approximate, with target precision) various target outputs 246, e.g., correctly detect and classify various objects and states of the objects. In some implementations, unified model 220 can be trained to have a reduced precision and/or resolution compared with the precision and/or resolution of the corresponding teacher model 243 that is specialized in the corresponding task. In some implementations, unified model 220 can have a precision and/or resolution that matches or even exceeds the precision and/or resolution of the corresponding teacher model 243, e.g., by virtue of learning and exploiting correlations between classifications of separate but related tasks.

The data repository 250 can be a persistent storage capable of storing lidar/radar/camera/IR camera images and other data, as well as data structures configured to facilitate training of one or more unified models using multiple teacher models. The stored data can include various annotations and mapping data, including annotations prepared by human developers as well as annotations generated by teacher models. The data repository 250 can be hosted by one or more storage devices, such as main memory, magnetic or optical storage disks, tapes, or hard drives, network-attached storage (NAS), storage area network (SAN), and so forth. Although depicted as separate from training server 240, in an implementation, the data repository 250 can be a part of training server 240. In some implementations, data repository 250 can be a network-attached file server, while in other implementations, data repository 250 can be some other type of persistent storage such as an object-oriented database, a relational database, and so forth, that can be hosted by a server machine or one or more different machines accessible to the training server 240 via a network (not shown in FIG. 2).

FIG. 3 is a schematic diagram illustrating example operations 300 performed during training of multiple teacher models, in accordance with some implementations of the present disclosure. Operations 300 illustrated in FIG. 3 can be implemented by training server 240 of FIG. 2 as part of the training of multiple teacher models 320-n. It should be understood that FIG. 3 depicts merely one example architecture of teacher models 320-n and that operations 300 can be used to train teacher models of any suitable architectures. Teacher models 320-n can include neural networks (NNs), which can include any number of subnetworks. Neurons in the networks can be associated with learnable weights and biases. The neurons can be arranged in layers. Some of the layers can be hidden layers. Each of the NNs or subnetworks depicted in FIG. 3 can include multiple hidden neuron layers and can be configured to perform one or more functions that facilitate detection of objects as well as classification of objects and states of the objects.

In some implementations, different teacher models 320-n can be trained using the same input data 301 (e.g., the same images), the data obtained using the same sensing modalities, the data having the same resolution, dimensions, and so on. In some implementations, input data 301 used for training different teacher models can be different (e.g., different images for different tasks) but can be obtained for similar environments (e.g., urban driving environments). Input data 301 into teacher models 320-n can include data from one or multiple sensing modalities, including but not limited to a lidar data 302, a radar data 304, a camera data 306, an IR data 308, and the like. Each of the input data can have a digital pixelated form representing three-dimensional (3D) intensity maps I(x₁, x₂, x₃) or a two-dimensional (2D) intensity maps, I(x₁, x₂). In some implementations, 2D intensity maps (e.g., lidar and/or radar intensity maps) can represent a specific slice of the 3D intensity for a specific height x₃=h above the ground, e.g., I(x₁, x₂, h), or a maximum value with respect to the vertical coordinate, I(x₁, x₂)={I(x₁, x₂, x₃): x₃}, or an average value of I(x₁, x₂, x₃) within some interval of heights, x₃∈(a, b), or some other suitable value. In some implementations, lidar data 302 and/or radar data 304 can include a 3D Doppler shift/velocity intensity map V(x₁, x₂, x₃) or its corresponding 2D projection (e.g., determined as described above fin relation to the intensity I). It should be understood that coordinates (x₁, x₂, x₃) or (x₁, x₂) are not limited to Cartesian coordinates and can include any suitable system of coordinates, e.g., a spherical coordinate system, cylindrical coordinate system, elliptical coordinate system, polar coordinate system, and so on. In some implementations, a coordinate system can be a non-orthogonal coordinate system, e.g., an affine coordinate system.

Camera data 306 and IR data 308 can include images in any suitable digital format (e.g., JPEG, TIFF, GIG, BMP, CGM, SVG, and so on). Each image can include a number of pixels. The number of pixels can depend on the resolution of the image. Each pixel can be characterized by one or more intensity values. A black-and-white pixel can be characterized by one intensity value representing the brightness of the pixel, with value 1 corresponding to a white pixel and value 0 corresponding to a black pixel (or vice versa). The intensity value can assume continuous (or discretized) values between 0 and 1 (or between any other chosen limits, e.g., 0 and 255). Similarly, a color pixel can be represented by more than one intensity value, e.g., by three intensity values (e.g., if the RGB color encoding scheme is used) or four intensity values (e.g., if the CMYK color encoding scheme is used). Each of the images in the input data 301 can be preprocessed prior to being input into teacher models 320-n, e.g., downscaled (with multiple pixel intensity values combined into a single pixel value), upsampled, filtered, denoised, and the like.

In some implementations, images included in input data 301 (e.g., any of camera data 306 and IR data 308, as well as in lidar data 302 and/or radar data 304) can be large images that depict the same (or approximately the same) region of the driving environment. In some implementations, input data 301 can include portions (patches) of the larger images, cropped by cropping and normalization module 209 (not shown), as described above in relation to FIG. 2. In some implementations, input data 301 can be combined into frames 310-1 . . . 310-N associated with different instances of time t₁ . . . t_{N}, different frames being processed by teacher models 320-n concurrently or in a pipelined fashion.

Each teacher model 320-n can include a frame-level model (FLM) 322 and a temporal fusion model (TFM) 328. FLM 322 can process each frame 310-n individually and identify various objects represented by the respective frame data. FLM 322 can be any suitable model trained to identify objects within input data 301. In some implementations, FLM 310 can include multiple convolutional neuron layers and one or more fully-connected layers. The convolutions performed by FLM 310 can include any number of kernels of different dimensions trained to capture both the local as well as global context within the input frames (images). The output of FLM 310 can include a set of feature vectors 324, which can include feature tensors, matrices, and so on. Feature vectors 324 may characterize geolocations of the detected objects, such as bounding boxes (rectangular or non-rectangular) for the objects, position and orientation of the objects on the roadway and/or relative to other objects. Feature vectors 324 can further include (e.g., in an encoded form) any additional semantic information, which can be an embedding characterizing an appearance of the object (e.g., shape, color, representative features, etc.), and the like.

In some implementations, a tracking module (not shown in FIG. 3) can perform associations of objects in different frames 310-n. For example, the tracking module can sort through various objects identified by FLM 322 in different frames 310-n and identify depictions of the same object in these frames. For example, if different frames 310-n contain depictions of a pedestrian, a car and a bus, the tracking module can link depictions of the same objects (e.g., a pedestrian) in different frames 310-n. The tracking module can use closeness of locations of the objects in different frames, sizes and poses of the objects, similarity of semantic information (e.g., included in the respective feature vectors 324), and so on. Feature vectors 324 associated with the same objects can then be combined into fused feature vectors 326, which can be any associations of feature vectors 324. For example, feature vectors 324 can be concatenated together for concurrent processing. In some implementations, fused feature vectors 324 can be arranged as an ordered (e.g., in a chronological order) sequence of feature vectors 324 and processed one by one (e.g., in a pipelined fashion).

Fused feature vectors 326 can be processed by a temporal fusion model (TFM) 328. TFM 328 can include one or more fully-connected layers, although TFM 328 can have any other suitable architecture, e.g., convolutional network architecture, transformer network architecture, and the like. The output of TFM can include classification outputs 340. Classification outputs 340 can include ultimate classifications of various objects, e.g., turning lights right-on/left-on/off, hazard lights on/off, braking lights on/off, and so on. Ultimate classifications can be exclusive, e.g., can provide a single most likely class of an object or a state of the object. Additionally, classification outputs 340 can include an entire distribution (soft classifications) of probabilities {pᵢ} over multiple classes, i=1 . . . K. In some implementations, classification outputs 340 can include logits zᵢ that are output by the second to the last layer of TFM 328 (e.g., inputs into the last, softmax classification layer of TFM 328), such that zᵢ=C+In In pᵢ, with some normalization constant C. In some implementations, outputs of TFM 328 can include embeddings 342, which may include any additional intermediate outputs of preceding layers of TFM 328.

Classification outputs 340 (e.g., ultimate outputs) can be compared to ground truth 330, which may be a manually annotated (labeled) ground truth. The computed difference between classification outputs 340 and ground truth 330 can be evaluated (using any suitable loss function) and backpropagated through the neuron layers of FLM 322 and TFM 328 to adjust parameters of FLM 322 and TFM 328 in a way that minimizes the computed difference.

Additional input data 301 can be processed similarly, followed by backpropagation and further adjustment of the parameters of each of the teacher models 320-1, 320-2 . . . 320-M until the training of the models is complete. The trained teacher models 320-1, 320-2 . . . 320-M are specialized models trained to perform limited tasks but with a high accuracy and confidence. Trained teacher models 320-1, 320-2 . . . 320-M can subsequently be used to generate ground truth for training of unified models. More specifically, an input data 301 can be processed by teacher model 320-n and the corresponding output can be stored as ground truth teacher 350-n. Input data 301 can be the same as the input data used for training of the teacher model 320-n or an input data previously not seen by teacher model 320-n. Since ground truth teacher 350-n is automatically labeled (by teacher model 320-n) ground truth, it can be produced without expensive and time-consuming manual labeling by a human developer. Consequently, operations 300 enable generation of a large number of annotated training inputs for training of the unified models, as described below in relation to FIG. 4.

FIG. 4 is a schematic diagram illustrating example operations 400 performed during training of a unified model capable of performing multiple tasks, in accordance with some implementations of the present disclosure. Input data 401 can include data of any sensing modalities that were used to train the teacher models, e.g., lidar data 402, radar data 404, camera data 406, IR data 408, ultrasound sonar data (not shown), and the like. Sensing data of different modalities corresponding to the same sensing times can be grouped into frames 410-1 . . . 410-N and can further be cropped and normalized by a module (not shown in FIG. 4) that operates similarly to cropping and normalization module 209 of FIG. 2. Cropping can be performed using an output of a detector model (not shown in FIG. 4) that identifies various objects located within a field of view covered by input data 401. The detector model can associate a set of object embeddings 420 with each of the detected objects. Object embeddings 420 can be any digital representations of the detected objects and can characterize appearance, size, pose, and other characteristics of the object. In some implementations, object embeddings 420 can include a representation of pixels of the cropped portion of a given frame. In some implementations, object embeddings 420 can include clusters of points (e.g., lidar return points, radar return points, etc.) associated with specific objects and obtained using various methods of clusterization, including iterative closest point (ICP) algorithm or any other suitable algorithm.

Data-object matching module 422 can match objects to input data 401 and, in particular, use a tracking module 424 to link (match) data associated with different frames that corresponds to the same objects. In some implementations, tracking module 424 can perform simulations using various physical models that describe motion of objects, such as models of translational and rotational motion of objects. Using these or other techniques, tracking module 424 can link together object embeddings 420 that are associated with depictions of the same objects in consecutive frames. Such linked object embeddings 420 can be fused together and input into a unified model 430 that is being trained. Fusion of object embeddings 420 can be performed by concatenating object embeddings 420 corresponding to the same object and processing concatenated embeddings by unified model 430. In some implementations, fusion of object embeddings 420 can be performed by forming a time-ordered sequence of object embeddings 420 and processing the ordered embeddings by unified model 430 sequentially (e.g., using pipelined processing).

Unified model 430 can process the fused object embeddings to obtain multiple task predictions 440-1 . . . 440-M, each task prediction 440-n representing a classification for a particular task (category) and over multiple classes associated with that respective task (category). Each task prediction 440-n can be made for a specific task that a respective teacher model 320-n (as shown in FIG. 3) is trained to perform. A specific task prediction 440-n can include a set of probabilities pᵢ representing the likelihood that a given object (or a state of the object) belongs to a particular class i. For example, if the task is to identify the status of the turning lights of a vehicle, probability p₁ can represent the likelihood that the turning lights are inactive, probability p₂ can represent the likelihood that the left turning light is activated (“left turn” signal), probability p₃ can represent the likelihood that the right turning light is activated (“right turn” signal), and probability p₄ can represent the likelihood that the both turning lights are activated (“hazard” signal). If the task is to determine whether the same (or another) vehicle is to maintain its lane of travel, probability p₁ can represent the likelihood that the vehicle is to maintain the lane for the next 3 seconds, probability p₂ can represent the likelihood that the vehicle is to move over to the right lane within the next 3 seconds, probability p₃ can represent the likelihood that the vehicle is to move over to the left lane within the next 3 seconds, and probability p₄ can represent the likelihood that the vehicle is to make a U-turn within the next 3 seconds.

Task predictions 440-n can be compared, using a loss function 460, to a ground truth. The ground truth can include auto-labeled ground truth and manually-labeled ground truth. The auto-labeled ground truth can include classification outputs (e.g., ultimate classifications and soft classification) for each of the teacher models 320-n (as illustrated in FIG. 3). More specifically, teacher model 320-n can process the same input data 401 (e.g., previously or concurrently with the processing of the same input data by unified model 430), and output classification probabilities as part of ground-truth teacher 450-n. The classification probabilities can include the outputs of the classifier layer of the respective teacher model 320-n or the outputs (e.g., logits) the layer that feeds data into the classifier layer of the teacher model 320-n. In some implementations, ground-truth 450-n can further include any suitable intermediate outputs of previous (hidden) layers of the teacher model. In some implementations, manually-labeled ground truth 452 can also be used and can include human operator-made annotations, which can include correct classifications for at least some images of input data 401.

Loss function 460 can include a suitable loss function (cost function), e.g., the mean square loss function, the cross-entropy loss function, the mean absolute error loss function, the mean bias error loss function, hinge loss function, and so on. The differences between task predictions 440-n and ground truth teacher 450-n (as well as manually-labeled ground truth 452) evaluated using loss function 460 can then be backpropagated to adjust parameters of unified model 430 in a way that minimizes the differences.

The teacher-student framework disclosed in conjunction with FIG. 3 and FIG. 4 provides an efficient platform to developers for training and deployment of machine learning models. In particular, since the teacher models do not need to be installed on a vehicle's perception system and can operate fully off-board, the teacher models can be developed without rigid constraints on the model architecture, e.g., the number of neuron layers, the number of neurons in the layers, the number of connections between layers, and so on. Furthermore, different teacher models can operate independently from each other. As a result, teacher models can be developed in parallel, by separate developers (or groups of developers) deploying any appropriate resources that may improve performance of the models. The trained teacher models can then be used to annotate (referred above as auto-labeling) various objects for training of a student unified model that can be used on-board, in a vehicle, traffic control system, animal control, public or private security system, and the like. As described above, the annotations can include probabilities or other soft classifications, as well as intermediate outputs of neural networks. The annotations can be stored in an off-board log as part of a labeling database that is used to train one or more unified models. A given object can be given multiple sets of annotations, each set associated with a specific task and provided by a respective teacher model. The automated annotations allow labeling various objects fully (exhaustively) and avoid the “partial label” problem (missed annotations for some objects) that often affects conventional training processes deploying manual labeling. Moreover, auto-labeling annotations can be generated (by teacher models) in quantities exceeding significantly the amount of annotations that a human developer can conceivably prepare. It should be understood, however, that the use of the auto-labeling annotations does not preclude a concurrent (or additional) use of the manual labeling, as both types of the annotations can be used as the ground truth during training of unified models.

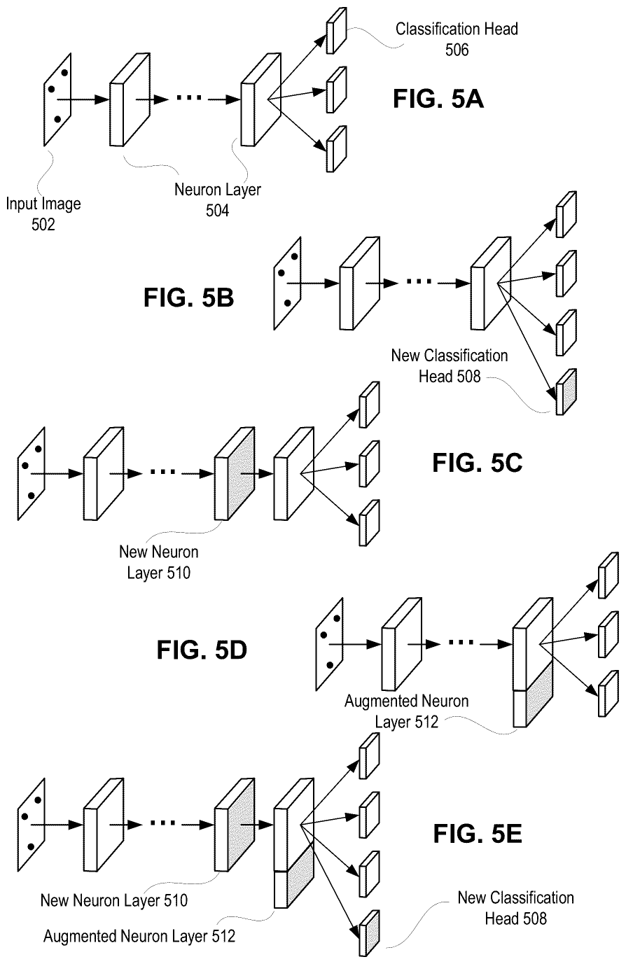

Furthermore, the disclosed teacher-student training framework enables efficient updating of a unified model when additional ground truth becomes available (e.g., additional input data, manually or automatically annotated) or teaching the unified model a new task. FIGS. 5A-D illustrate schematically a framework for updating a unified model to perform an additional task or to improve performance of an existing task, in accordance with some implementations of the present disclosure. FIG. 5A depicts schematically an architecture of a unified model configured to process an input image 502 using multiple neuron layers 504 and a number of classification heads 506 whose number can be equal to the number of classification tasks performed by the unified mode. FIG. 5B depicts schematically updating an architecture of a unified model with a new classification head 508 (depicted as a shaded block). The new classification head 508 can have one or more additional layers of neurons that use, as an input, an output of the backbone of the unified model. The new classification head 508 can be trained, using a ground truth for the new task to output a new classification (over a new set of classes) of objects depicted in the input image. FIG. 5C depicts schematically updating an architecture of a unified model with a new neuron layer 510 (or multiple new neuron layers). FIG. 5D depicts schematically updating an architecture of a unified model by augmenting an existing neuron layer with additional neurons to obtain an augmented neuron layer 512. The new neuron layer 510 (as in FIG. 5C) or the augmentation of an existing layer (as in FIG. 5D) can be added in response to additional requirements (e.g., increased accuracy requirements) to the existing classification performed by the unified model or in response to an additional ground truth (training data) that becomes available. FIG. 5E depicts schematically updating an architecture of a unified model with a combination of updates illustrated in FIGS. 5B-D. The updates illustrated in FIG. 5E can be performed in response to any of the objectives referenced above in relation to FIGS. 5B-D.

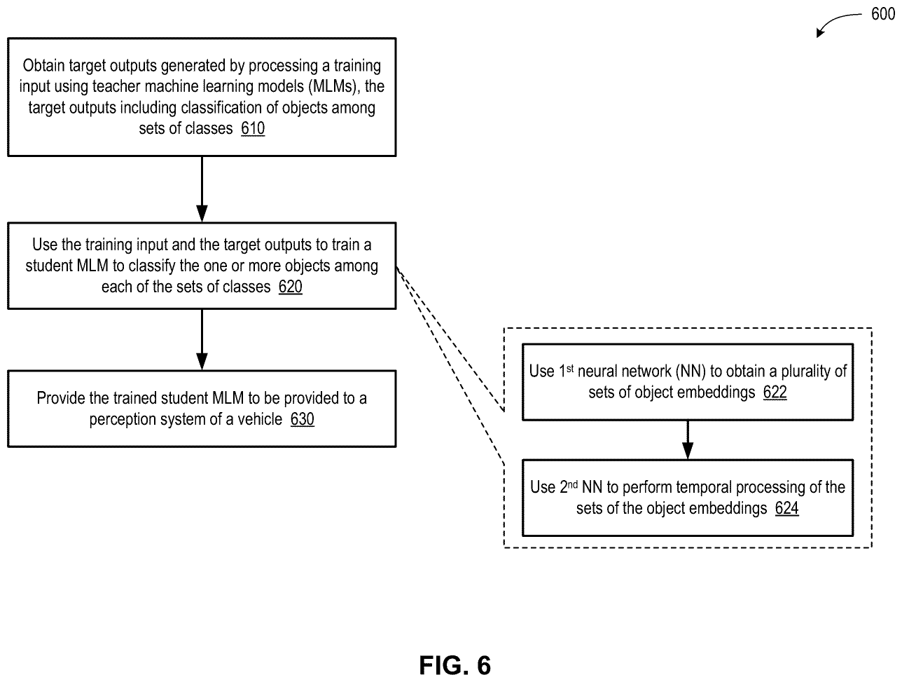

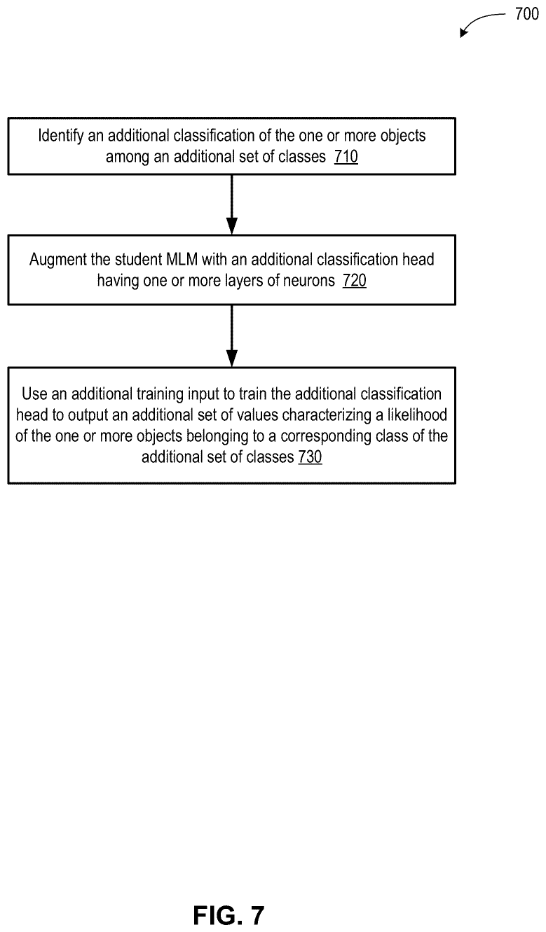

FIGS. 6-7 illustrate example methods 600-700 that can be used to train and deploy a unified MLM using multiple teacher MLMs and capable of performing multiple classification tasks. A processing device, having one or more processing units (CPUs) and memory devices communicatively coupled to the CPU(s), can perform methods 600-700 and/or each of their individual functions, routines, subroutines, or operations. The processing device executing methods 600-700 can perform instructions issued by various components of the data processing system 120 of FIG. 1, training server 240 of FIG. 2, etc. In some implementations, methods 600-700 can be directed to improving systems and components of an autonomous driving vehicle, such as the autonomous vehicle 100 of FIG. 1. Methods 600-700 can be used to improve performance of the processing system 120 and/or the autonomous vehicle control system 140. In certain implementations, a single processing thread can perform methods 600-700. Alternatively, two or more processing threads can perform methods 600-700, each thread executing one or more individual functions, routines, subroutines, or operations of the methods. In an illustrative example, the processing threads implementing methods 600-700 can be synchronized (e.g., using semaphores, critical sections, and/or other thread synchronization mechanisms). Alternatively, the processing threads implementing methods 600-700 can be executed asynchronously with respect to each other. Various operations of methods 600-700 can be performed in a different order compared with the order shown in FIGS. 6-7. Some operations of methods 600-700 can be performed concurrently with other operations. Some operations can be optional.

FIG. 6 illustrates an example method 600 of training, using multiple teacher models, of a unified model capable of performing multiple tasks, in accordance with some implementations of the present disclosure. Method 600 can use input data obtained by scanning an environment of a vehicle (or any other relevant environment) using a plurality of sensors of the sensing system of the vehicle (or any other relevant system). The sensing system can include one or more lidar sensors, radar sensors, optical range cameras, IR cameras, and/or other sensors. Optical range and/or IR cameras can include panoramic (surround-view) cameras, partially panoramic cameras, high-definition (high-resolution) cameras, close-view cameras, cameras having a fixed field of view (relative to the AV), cameras having a dynamic (adjustable) field of view, cameras having a fixed or adjustable focal distance, cameras having a fixed or adjustable numerical aperture, and any other suitable cameras. Optical range cameras can further include night-vision cameras. Input data should be understood as any data obtained by any sensors of the sensing system, including raw (unprocessed) data, low-level (minimally processed) data, high-level (fully processed) data, and so on. Input data can include images, which should be understood as any arrays, tables or other collections of digital data (e.g., of data pixels) that represents the sensing data and maps detected intensity (or any function of the detected intensity, e.g., inferred temperature of detected objects) to various spatial locations in the environment. Images can include various metadata that provides geometric associations between image pixels and spatial locations of objects, correspondence of pixels of one image (e.g., a lidar image) and pixels of another image (e.g., a camera image), and so on. The detected intensities can refer to the magnitude of electromagnetic signals detected by various sensors as well as Doppler shift (radial velocity) data, as can be obtained by lidar and/or radar sensors.

At block 610, method 600 can include obtaining a plurality of target outputs. Each of the plurality of target outputs can be generated by processing a training input using a respective teacher MLM of a plurality of teacher MLMs. The training input can include any representation of one or more objects. In particular, the representation of the one or more objects can include at least one of a camera image of the one or more objects, a lidar image of the one or more objects, or a radar image of the one or more objects, a sonar image of the one or more objects, and the like. In some implementations, the training input can include a plurality of frames, each of the plurality of frames depicting the one or more objects at a respective one of a plurality of times.

Each of the plurality of target outputs can include a classification of the one or more objects among a respective set of classes of a plurality of sets of classes. For example, a first set of classes can correspond to an object type category (pedestrian/car/truck/motorcycle/etc.), a second set of classes can correspond to a motion type category (steady/acceleration/deceleration/turn/lane change), a third set of classes can correspond to operations of lights of the object (off/on/blinking/left turn/right turn/etc.), and the like. In some implementations, the classification of the one or more objects among the respective set of classes can include a set of values, wherein each value of the set of values characterizes a likelihood of the one or more objects belonging to a corresponding class of the respective set of classes. For example, the set of values can be a set of probabilities {pᵢ} of the one or more objects belonging to a corresponding class. In some implementations, the set of values can be any other set of parameters related to the respective probabilities, e.g., a set of logits {zᵢ} that being input into a softmax classifier (or any other suitable classifier) determine the respective probabilities, e.g.,

$${p}_{i} = \frac{exp ( {z}_{i} )}{\begin{matrix}{\sum }_{j} & exp ( {z}_{j} )\end{matrix}} .$$

In some implementations, the plurality of target outputs can include any additional intermediate outputs of at least one of the plurality of teacher MLMs. In some implementations, one or more of the plurality of target outputs can further include one or more manual annotations for at least one of the one or more objects.

At block 620, method 600 can continue with using the training input and the plurality of target outputs to train a student MLM to classify the one or more objects among each of the plurality of sets of classes. In some implementations, the MLM can be trained to perform all or at least some of the tasks that different teacher MLMs are trained to do. In some implementations, the student MLM can include a common backbone of neural layers and a plurality of classification heads. Each classification head of the plurality of classification heads can output a classification of the one or more objects among a respective set of the plurality of sets of classes. As depicted with the callout portion of FIG. 6, using the training input to train the student MLM can include, at block 622, using a first neural network (NN) to obtain a plurality of sets of object embeddings. Each of the plurality of sets of object embeddings can be associated with a respective time of the plurality of times. At block 624, method 600 can include using a second NN to perform a temporal processing of the plurality of sets of the object embeddings. In some implementations, performing the temporal processing can include performing a concurrent attention-based processing of the plurality of sets of the object embeddings. In some implementations, performing the temporal processing can include performing a sequential memory-based processing of the plurality of sets of the object embeddings.

At the completion of the training, at block 630, the trained student MLM can be provided to a perception system of a vehicle, e.g., a vehicle equipped with any suitable driver assistance system or a vehicle capable of autonomous driving under at least some road conditions.

FIG. 7 illustrates an example method 700 of augmenting training of a unified model to perform additional tasks, in accordance with some implementations of the present disclosure. Method 700 can use additional input data, e.g., previously unseen by the unified model, that is related to a new task. The new task can be associated with an additional set of classes and can include a task performed by one of the teacher models previously not used for training of the unified model (e.g., a newly developed teacher model). At block 710, method 700 can include identifying an additional classification of the one or more objects among the additional set of classes. At block 720, method 700 can continue with augmenting the student MLM with an additional classification head. The additional classification head can include one or more layers of neurons. At block 730, method 700 can include using an additional training input to train the additional classification head to output an additional set of values. The additional set of values can characterize a likelihood of the one or more objects belonging to a corresponding class of the additional set of classes. The additional training input may be generated by an additional specialized teacher model developed and trained (e.g., offboard) to perform the additional classification.

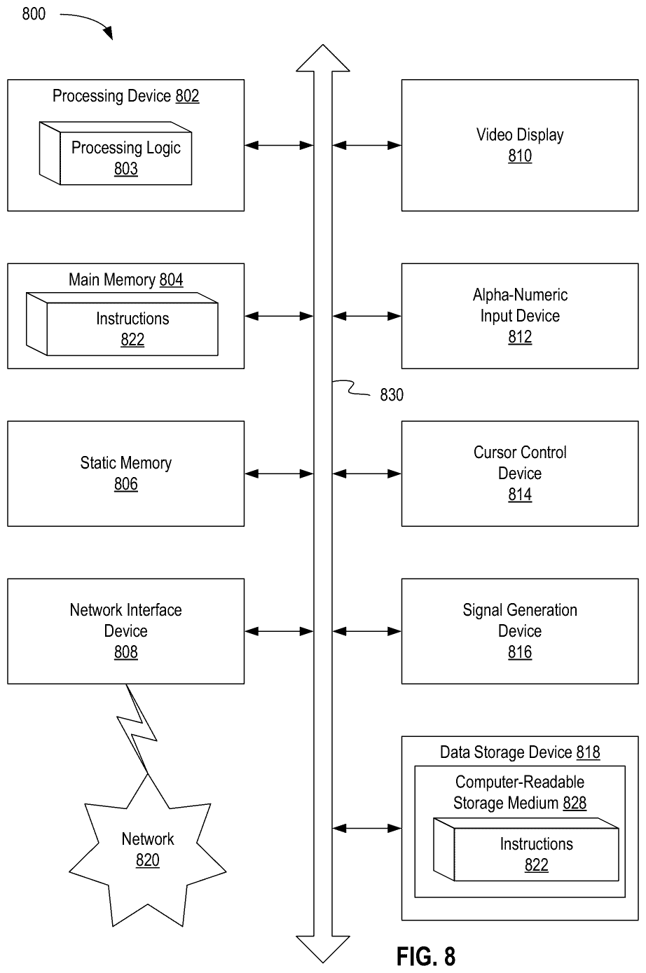

FIG. 8 depicts a block diagram of an example computer device 800 capable of training one or more unified models using multiple teacher models, in accordance with some implementations of the present disclosure. Example computer device 800 can be connected to other computer devices in a LAN, an intranet, an extranet, and/or the Internet. Computer device 800 can operate in the capacity of a server in a client-server network environment. Computer device 800 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 800 can include a processing device 802 (also referred to as a processor or CPU), a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory (e.g., a data storage device 818), which can communicate with each other via a bus 830.

Processing device 802 (which can include processing logic 803) represents one or more general-purpose processing devices such as a microprocessor, central processing unit, or the like. More particularly, processing device 802 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 802 can be configured to execute instructions performing method 600 of training, using multiple teacher models, of a unified model capable of performing multiple tasks and method 700 of augmenting training of a unified model to perform additional tasks.

Example computer device 800 can further comprise a network interface device 808, which can be communicatively coupled to a network 820. Example computer device 800 can further comprise a video display 810 (e.g., a liquid crystal display (LCD), a touch screen, or a cathode ray tube (CRT)), an alphanumeric input device 812 (e.g., a keyboard), a cursor control device 814 (e.g., a mouse), and an acoustic signal generation device 816 (e.g., a speaker).

Data storage device 818 can include a computer-readable storage medium (or, more specifically, a non-transitory computer-readable storage medium) 828 on which is stored one or more sets of executable instructions 822. In accordance with one or more aspects of the present disclosure, executable instructions 822 can comprise executable instructions performing method 600 of training, using multiple teacher models, of a unified model capable of performing multiple tasks and method 700 of augmenting training of a unified model to perform additional tasks.

Executable instructions 822 can also reside, completely or at least partially, within main memory 804 and/or within processing device 802 during execution thereof by example computer device 800, main memory 804 and processing device 802 also constituting computer-readable storage media. Executable instructions 822 can further be transmitted or received over a network via network interface device 808.

While the computer-readable storage medium 828 is shown in FIG. 8 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method comprising:
obtaining a plurality of target outputs,
wherein each of the plurality of target outputs comprises a classification of a training input among a respective set of classes of a plurality of sets of classes,
wherein each of the plurality of sets of classes is obtained using a respective teacher machine learning model (MLM) of a plurality of teacher MLMs, and
wherein the training input comprises a representation of one or more objects; and
using the training input and the plurality of target outputs to train a student MLM to classify the one or more objects among each of the plurality of sets of classes.

2. The method of claim 1, wherein the representation of the one or more objects comprises at least one of a camera image of the one or more objects, a lidar image of the one or more objects, or a radar image of the one or more objects.

3. The method of claim 1, wherein the plurality of target outputs comprise intermediate outputs of at least one of the plurality of teacher MLMs.

4. The method of claim 1, wherein the classification of the training input among the respective set of classes comprises a set of values, wherein each value of the set of values characterizes a likelihood of the one or more objects belonging to a corresponding class of the respective set of classes.

5. The method of claim 4, wherein the training input comprises a plurality of frames, wherein each of the plurality of frames depicts the one or more objects at a respective one of a plurality of times.

6. The method of claim 5, wherein using the training input to train the student MLM comprises:
using a first neural network (NN) to obtain a plurality of sets of object embeddings, wherein each of the plurality of sets of object embeddings is associated with a respective time of the plurality of times; and
using a second NN to perform a temporal processing of the plurality of sets of the object embeddings, wherein performing the temporal processing comprises at least one of:
performing a concurrent attention-based processing of the plurality of sets of the object embeddings, or
performing a sequential memory-based processing of the plurality of sets of the object embeddings.

7. The method of claim 1, wherein one or more of the plurality of target outputs further comprise one or more manual annotations for at least one of the one or more objects.

8. The method of claim 1, wherein the student MLM comprises a common backbone of neural layers and a plurality of classification heads, each classification head of the plurality of classification heads outputting a classification of the one or more objects among a respective set of the plurality of sets of classes.

9. The method of claim 8, further comprising:
identifying an additional classification of the one or more objects among an additional set of classes, the additional classification associated with an additional teacher MLM;
augmenting the student MLM with an additional classification head, wherein the additional classification head comprises one or more layers of neurons; and
using an additional training input, generated by the additional teacher MLM, to train the additional classification head to output an additional set of values, wherein each value of the additional set of values characterizes a likelihood of the one or more objects belonging to a corresponding class of the additional set of classes.

10. The method of claim 1, further comprising:
causing the trained student MLM to be provided to a perception system of a vehicle.

11. A system comprising:
a memory device; and
a processing device communicatively coupled to the memory device, the processing device configured to:
obtain a plurality of target outputs,
wherein each of the plurality of target outputs comprises a classification of a training input among a respective set of classes of a plurality of sets of classes,
wherein each of the plurality of sets of classes is obtained using a respective teacher machine learning model (MLM) of a plurality of teacher MLMs, and
wherein the training input comprises a representation of one or more objects; and
use the training input and the plurality of target outputs to train a student MLM to classify the one or more objects among each of the plurality of sets of classes.

12. The system of claim 11, wherein the representation of the one or more objects comprises at least one of a camera image of the one or more objects, a lidar image of the one or more objects, or a radar image of the one or more objects.

13. The system of claim 11, wherein the plurality of target outputs comprise intermediate outputs of at least one of the plurality of teacher MLMs.

14. The system of claim 11, wherein the classification of the training input among the respective set of classes comprises a set of values, wherein each value of the set of values characterizes a likelihood of the one or more objects belonging to a corresponding class of the respective set of classes.

15. The system of claim 14, wherein the training input comprises a plurality of frames, each of the plurality of frames depicting the one or more objects at a respective one of a plurality of times, and wherein to use the training input to train the student MLM, the processing device is configured to:
use a first neural network (NN) to obtain a plurality of sets of object embeddings, wherein each of the plurality of sets of object embeddings is associated with a respective time of the plurality of times; and
use a second NN to perform a temporal processing of the plurality of sets of the object embeddings, wherein to perform the temporal processing, the processing device is to perform at least one of:
a concurrent attention-based processing of the plurality of sets of the object embeddings, or
a sequential memory-based processing of the plurality of sets of the object embeddings.

16. The system of claim 11, wherein one or more of the plurality of target outputs further comprise one or more manual annotations for at least one of the one or more objects.

17. The system of claim 11, wherein the student MLM comprises a common backbone of neural layers and a plurality of classification heads, each classification head of the plurality of classification heads outputting a classification of the one or more objects among a respective set of the plurality of sets of classes.

18. The system of claim 17, wherein the processing device is further configured to:
identify an additional classification of the one or more objects among an additional set of classes;
augment the student MLM with an additional classification head, wherein the additional classification head comprises one or more layers of neurons; and
use an additional training input to train the additional classification head to output an additional set of values, wherein each value of the additional set of values characterizes a likelihood of the one or more objects belonging to a corresponding class of the additional set of classes.

19. The system of claim 11, wherein the processing device is further configured to:
cause the trained student MLM to be provided to a perception system of a vehicle.

20. A non-transitory computer-readable medium storing instructions thereon that, when executed by a processing device, cause the processing device to perform operations comprising:
obtaining a plurality of target outputs,
wherein each of the plurality of target outputs comprises a classification of a training input among a respective set of classes of a plurality of sets of classes,
wherein wherein each of the plurality of sets of classes is obtained using a respective teacher machine learning model (MLM) of a plurality of teacher MLMs, and
wherein the training input comprises a representation of one or more objects; and
using the training input and the plurality of target outputs to train a student MLM to classify the one or more objects among each of the plurality of sets of classes.
